(19) United States
(12) Patent Application Publication
(10) Pub. No.: US 2008/0268860 A1
(43) Pub. Date: Oct. 30, 2008

(54) Coherent and non-coherent control signaling

(75) Inventors: Timo Lunttila, Espoo (FI); Jari Lindholm, Palojoki (FI)

Correspondence Address: HARRINGTON & SMITH, PC, 4 RESEARCH DRIVE, SHELTON, CT, 06484-6212, US

(73) Assignee: Nokia Siemens Networks Oy

(21) Appl. No.: 12/150,019

(22) Filed: Apr. 24, 2008

Related U.S. Application Data
(60) Provisional application No. 60/926,479, filed on Apr. 27, 2007.

(51) Int. Cl. H04Q 7/20

(52) U.S. Cl. 455/450

(57) ABSTRACT

A method is provided where unused uplink code resources of a shared control resource are used for non-coherent acknowledgement/negative acknowledgement transmission to increase the total number of user equipment that can be supported. The method including defining a shared uplink control resource to include N out of a possible M uplink control resources as being coherent uplink control resources, where M>N, defining at least one of the remaining M−N uplink control resources as non-coherent uplink control resources, and assigning the N coherent uplink control channel resources and the at least one M−N non-coherent uplink control resources to user equipment as needed.

### CROSS-REFERENCE TO RELATED APPLICATIONS

This patent application claims priority under 35 U.S.C. §119(e) from Provisional Patent Application No. 60/926,479 filed Apr. 27, 2007, the disclosure of which is incorporated by reference herein in its entirety.

### TECHNICAL FIELD

The exemplary and non-limiting embodiments of this invention relate generally to wireless communication systems, methods, devices and computer programs and, more specifically, relate to techniques for transmitting information from a user device to a wireless network device.

### BACKGROUND

Certain abbreviations that may be found in the description and/or in the Figures are herewith defined as follows:
3GPP Third Generation Partnership Project
ACK acknowledgement
BW bandwidth
CAZAC constant-amplitude zero auto-correlation
CDM code division multiplexing
CDMA code division multiple access
CM cubic metric
CP cyclic prefix
DFT discrete Fourier transform
DFT-S-OFDM discrete Fourier transform spread OFDM (SC-FDMA based on frequency domain processing)
E-UTRAN evolved UTRAN
FDM frequency division multiplexing
FDMA frequency division multiple access
FFT fast Fourier transform
IFFT inverse FFT
L1 Layer 1 (physical layer)
LB long block
LTE long term evolution
NACK negative acknowledgement
Node B Base Station
eNode B EUTRAN Node B
OFDM orthogonal frequency domain multiplex
PRB physical resource block
RAN radio access network
RB resource block
RS reference symbol
SR scheduling request
SF spreading factor
PUCCH physical uplink control channel
SC subcarrier
SC-FDMA single carrier, frequency division multiple access
TTI transmission time interval
UE user equipment
UL uplink
UTRAN universal terrestrial radio access network

A proposed communication system known as evolved UTRAN (E-UTRAN, also referred to as UTRAN-LTE) is currently under discussion within the 3GPP. The current working assumption is that the DL access technique will be OFDMA, and the UL technique will be SC-FDMA.

Reference can be made to 3GPP TR 36.211, V1.0.0 (2007-03), 3rd Generation Partnership Project; Technical Specification Group Radio Access Network; Physical Channels and Modulation (Release 8) for a description in Section 6 of the UL physical channels.

Reference can also be made to 3GPP TR 25.814, V7.1.0 (2006-09), 3rd Generation Partnership Project; Technical Specification Group Radio Access Network; Physical layer aspects for evolved Universal Terrestrial Radio Access (UTRA) (Release 7), such as generally in section 9.1 for a description of the SC-FDMA UL of E-UTRA.

In 3GPP there have been extensive discussions related to the UL reference signal structure. FIG. 1A reproduces FIG. 12 of 3GPP TS 36.211 and shows the UL slot format for a generic frame structure.

As is described in Section 9.1 of 3GPP TR 25.814, the basic uplink transmission scheme is single-carrier transmission (SC-FDMA) with cyclic prefix to achieve uplink inter-user orthogonality and to enable efficient frequency-domain equalization at the receiver side. Frequency-domain generation of the signal, sometimes known as DFT-spread OFDM (DFT S-OFDM), is assumed.

FIG. 1B shows the generation of pilot samples. An extended or truncated Zadoff-Chu symbol sequence is applied to an IFFT block via a sub-carrier mapping block. The sub-carrier mapping block determines which part of the spectrum is used for transmission by inserting a suitable number of zeros at the upper and/or lower end. A CP is inserted into the output of the IFFT block.

In the PUCCH sub-frame structure for the UL control signaling seven SC-FDMA symbols (also referred to herein as “LBs” for convenience) are currently defined per slot. A sub-frame consists of two slots. Three LBs are used for reference signals (pilot long blocks) for coherent demodulation. Four LBs are used for control and/or data transmission.

The current working assumption is that for the PUCCH the multiplexing within a PRB is performed using CDM and (localized) FDM is used for different resource blocks. In the PUCCH the bandwidth of one control and pilot signal always corresponds to one PRB=12 SCs.

Two types of CDM multiplexing are used both for data and pilot LBs. Multiplexing based on the usage of cyclic shifts provides nearly complete orthogonality between different cyclic shifts, if the length of cyclic shift is larger than the delay spread of radio channel. For example, with an assumption of a 5 microsecond delay spread in the radio channel, up to 12 orthogonal cyclic shifts within one LB can be achieved. Sequence sets for different cells are obtained by changing the sequence index.

Another type of CDM multiplexing is applied between LBs based on orthogonal covering sequences, e.g., Walsh or DFT spreading. For the data LBs the length of the covering sequence and thus the spreading factor is equal to the number of data LBs in a slot (four). For the pilot LBs the sequence length and the spreading factor is three, corresponding to the number of pilot LBs.

Of particular interest to the exemplary embodiments of this invention is control channel signaling and, in particular, the use of the PUCCH. It has been previously determined that ACK/NACK signaling in the UL should be transmitted using a combination of cyclic modulated CAZAC sequences and block spreading. The data (ACK/NACK) is to be transmitted coherently, that is, there are three reference symbols per slot.

General reference in this regard may be made to 3GPP TSG RAN WG1 #48 bis, 26th-30th Mar. 2007, St. Julian, Malta, “Link Analysis and Multiplexing Capability for UL ACK”, R1-071293, Qualcomm Europe.

It should be appreciated that the maximum number of UEs that can be multiplexed into the PUCCH sets a limitation as to the total number of UEs that LTE can support. A more efficient usage of the PUCCH would thus be beneficial in increasing the number of UEs that can be supported at any given time.

Reference with regard to control signal multiplexing can be made to R1-070395, “CDM based Control Signal multiplexing w/ and w/o additional RS”, Nokia, 3GPP TSG RAN WG1 Meeting #47 bis, Sorrento, Italy, Jan. 15-19, 2007.

### SUMMARY

In an exemplary aspect of the invention, there is a method comprising defining a shared uplink control resource to comprise N out of a possible M uplink control resources as being coherent uplink control resources, where M>N, defining at least one of the remaining M−N uplink control resources as non-coherent uplink control resources, and assigning the N coherent uplink control resources and the at least one M−N non-coherent uplink control resource to user equipment as needed.

In another exemplary aspect of the invention, there is a computer readable medium encoded with a computer program executable by a processor to perform actions, comprising defining a shared uplink control resource to comprise N out of a possible M uplink control resources as being coherent uplink control resources, where M>N, defining at least one of the remaining M−N uplink control resources as non-coherent uplink control resources, and assigning the N coherent uplink control resources and the at least one M−N non-coherent uplink control resource to user equipment as needed.

In another exemplary aspect of the invention, there is an apparatus, comprising a transmitter, a receiver, a processor coupled to a memory configured to define a shared uplink control resource to comprise N out of a possible M uplink control resources as being coherent uplink control resources, where M>N, the processor further configured to define at least one of the remaining M−N uplink control resources as non-coherent uplink control resources, and the processor coupled to the transmitter configured to assign the N coherent uplink control channel resources and the at least one M−N non-coherent uplink control resource to user equipment as needed.

In yet another exemplary aspect of the invention, there is an apparatus, comprising means for defining a shared uplink control resource to comprise N out of a possible M uplink control resources as being coherent uplink control resources, where M>N, means for defining at least one of the remaining M−N uplink control resources as non-coherent uplink control resources, and means for assigning the N coherent uplink control channel resources and the at least one M−N non-coherent uplink control resource to user equipment (UE) as needed.

In an exemplary aspect of the invention as stated above the means for defining and means for assigning comprises a processor coupled to a transmitter.

In still another exemplary aspect of the invention, there is an apparatus, comprising a receiver, a transmitter, and a processor configured to operate in response to the receiver receiving an assignment from a base station to use one of a coherent uplink shared control resource or a non-coherent uplink shared control resource for signaling via the transmitter to the base station.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1A reproduces FIG. 12 of 3GPP TS 36.211 and shows the UL slot format for a generic frame structure;

FIG. 1B is a block diagram that illustrates the generation of pilot samples for the 3GPP LTE SC-FDMA UL;

FIG. 2 shows a simplified block diagram of various electronic devices that are suitable for use in practicing the exemplary embodiments of this invention;

FIG. 3 shows the slot structure of the PUCCH;

FIG. 4A shows a block spreading code allocation table for ACK/NACKs;

FIG. 4B shows a block spreading code allocation table for reference symbols; and

FIG. 5 is a logic flow diagram that is illustrative of a method, and the operation of a computer program product, for a network element, such as the eNode B shown in FIG. 2.

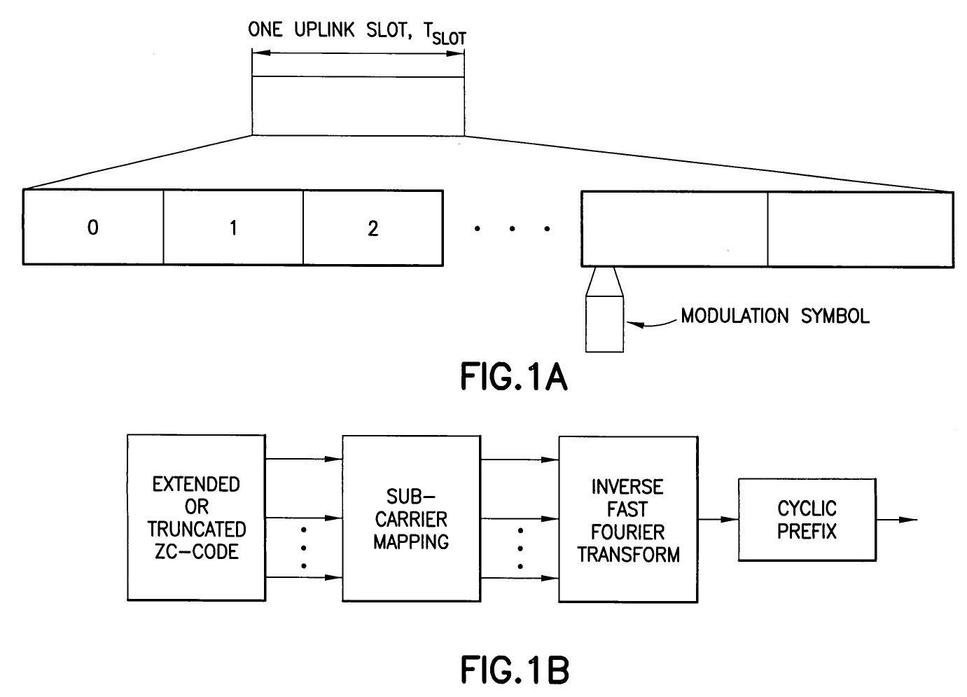

### DETAILED DESCRIPTION

The exemplary embodiments of this invention pertain generally to the UTRAN-LTE UL, and most particularly pertain to efficiently increasing the number of UE control signals multiplexed in the UL. In accordance with the exemplary embodiments of this invention unused UL code resources of a shared control resource are used for an ACK/NACK transmission without a separate reference signal to increase the total number of UEs that can be supported in LTE. In accordance with a non-limiting exemplary embodiment of the invention this transmission without a separate reference signal is referred to as a non-coherent ACK/NACK transmission.

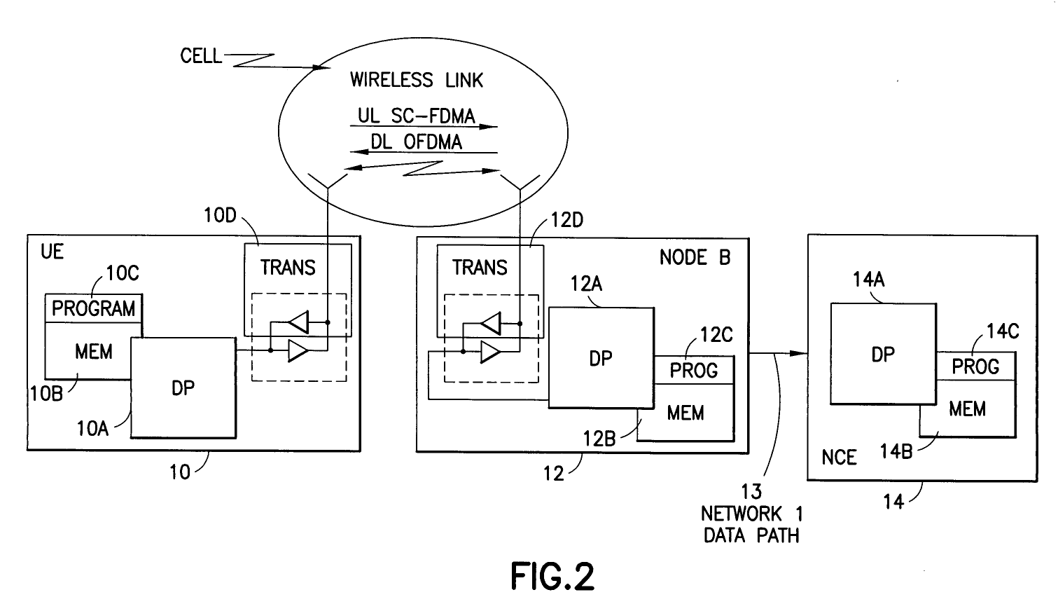

By way of introduction, reference is made to FIG. 2 for illustrating a simplified block diagram of various electronic devices that are suitable for use in practicing the exemplary embodiments of this invention. In FIG. 2 a wireless network 1 is adapted for communication with a UE 10 via at least one Node B 12 or similarly an eNode B 12, also referred to herein as a base station. The network 1 may include a network control element 14 coupled to the eNode B 12 via a data path 13. The UE 10 includes a data processor (DP) 10A, a memory (MEM) 10B that stores a program (PROG) 10C, and a suitable radio frequency (RF) transceiver 10D for bidirectional wireless communications with the eNode B 12, which also includes a DP 12A, a MEM 12B that stores a PROG 12C, and a suitable RF transceiver 12D. The eNode B 12 is typically coupled via the data path 13 to the network control element 14 that also includes at least one DP 14A and a MEM 14B storing an associated PROG 14C. At least one of the PROGs 10C and 12C is assumed to include program instructions that, when executed by the associated DP, enable the electronic device to operate in accordance with the exemplary embodiments of this invention, as will be discussed below in greater detail.

In a typical implementation there will be a plurality of UEs 10 that are present and that require the use of UL signaling.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 10A of the UE 10 and the DP 12A of the eNode B 12, or by hardware, or by a combination of software (and firmware) and hardware.

The MEMs 10B, 12B and 14B may be of any type suitable to the local technical environment and may be implemented using any suitable data storage technology, such as semiconductor-based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

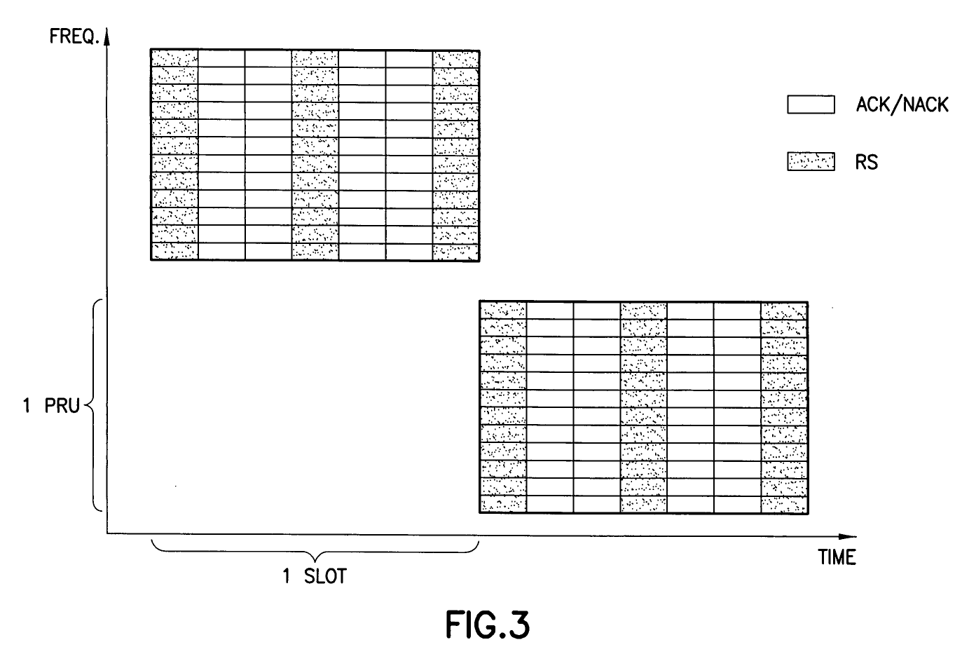

Discussing now in greater detail the exemplary embodiments of this invention, it is first noted that it has been agreed in 3GPP to utilize coherent modulation of cyclically-shifted CAZAC sequences, and block spreading (also known as orthogonal covering), for multiplexing ACK/NACK signals from different UEs 10 into the PUCCH. The slot structure is shown in FIG. 3. Three out of seven long blocks (LB), each consisting of 12 sub-carriers (SC), are reserved for reference symbols and four are used for the ACK/NACKs. Notice that the placement of the three pilot LBs may vary from what is shown in the drawing figure. CDMA is used for separating the different UEs 10. Within the LBs typically only six out of 12 cyclic shifts of the CAZAC sequences are used to ensure orthogonality between the sequences. Between LBs, block spreading with a SF of four (for ACK/NACKs) and three (for RSs) is utilized.

With coherent detection the number of users/signals that can be multiplexed is limited by the number of RSs. With six cyclic shifts and SF=3 a maximum of 18 simultaneous UEs 10 can be supported, which is an proposed understanding in 3GPP.

However, there are actually 24 different code resources available for ACK/NACK (SF=4 times 6 cyclic shifts), yet for only 18 of these codes are there RSs available.

In accordance with the exemplary embodiments of this invention the remaining unused codes (six codes in an exemplary and non-limiting case) are used in a non-coherent manner. For non-coherent ACK/NACK signaling, a single ACK/NACK requires two codes resources, one for ACK and one for NACK. Thus, in accordance with an exemplary embodiment of this invention the number of ACK/NACKs may be increased by three, from 18 to 21.

The use of the PUCCH for UL SRs has also been previously proposed in 3GPP. A SR requires only a single sequence to be transmitted non-coherently. Hence, in addition to the 18 coherent ACK/NACKs it is possible to transmit a total of six non-coherent SRs at the same time instant, without any significant performance degradation.

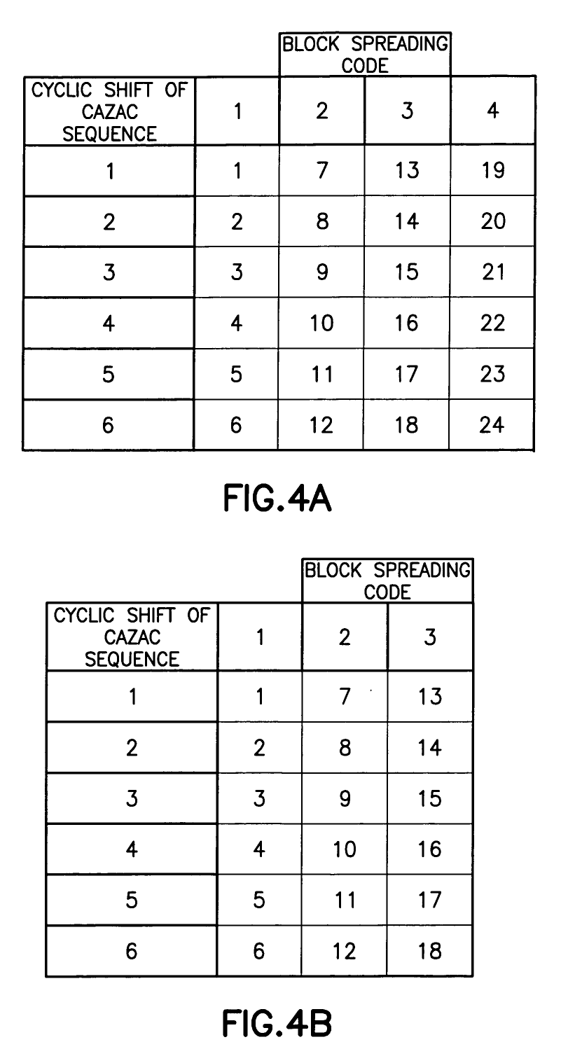

Examples of code allocation using both coherent and non-coherent signaling are shown in FIG. 4A and FIG. 4B, where it is assumed for convenience and not as a limitation that only six out of 12 cyclic shifts of the CAZAC sequences are used. The exact number of utilized cyclic shifts of the CAZAC sequences may be also, for example, 12 or 4, depending on the channel propagation properties. The 18 code combinations for the RSs of 18 users in FIG. 4B are implicitly mapped together with 18 coherent ACK/NACK code resources shown in FIG. 4A (1-18). The remaining 6 non-coherent resources (19-24) may then be allocated for other UEs 10 with ACK/NACK or SR.

Note that the presented examples are approximations, and that the exact order in which the codes are allocated and linked to one another may differ from what is shown and discussed. Note also that the division between the number of coherent ACK/NACKs and non-coherent ACK/NACKs or SRs is only exemplary, and that the ratio between supported ACK/NACKs and SRs can also be different.

Among the numerous advantages that are gained by the use of the exemplary embodiments of this invention is an increased multiplexing capability and an improved spectral efficiency.

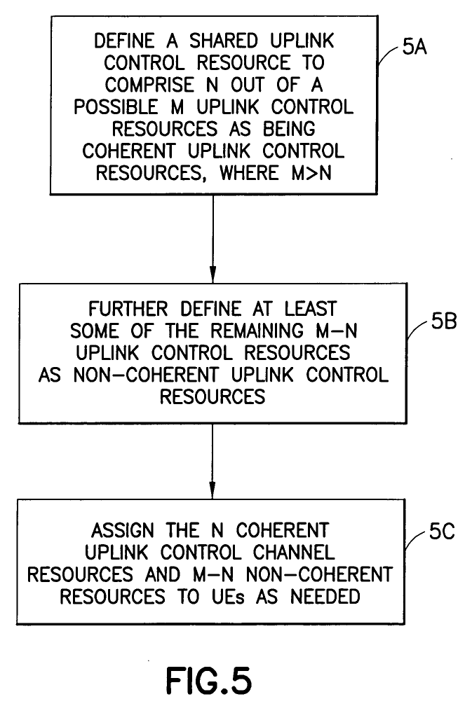

Based on the foregoing it should be apparent that the exemplary embodiments of this invention provide, in a non-limiting aspect thereof, a method, apparatus and computer program product to define, as shown in FIG. 5, a shared uplink control resource to comprise N out of a possible M uplink control resources as being coherent uplink control resources, where M>N (Block 5A), and to further define at least some of the remaining M−N uplink control resources as non-coherent uplink control resources (Block 5B). There is an additional operation of assigning the N coherent uplink control channel resources and M−N non-coherent uplink resources to UEs as needed (Block 5C). At least the operation of assigning can be performed by the Node B 12.

The method, apparatus and computer program product of the previous paragraph, where the uplink control resources are used for ACK/NACK signaling from UEs to a Node B.

The method, apparatus and computer program product of the previous paragraphs, where up to M−N UEs use one of the non-coherent uplink control resources for SR signaling to a Node B.

The method, apparatus and computer program product of the previous paragraphs, where the shared uplink control resource is comprised of a PUCCH.

The method, apparatus and computer program product of the previous paragraphs, further comprising assigning one of the N coherent uplink control resources to a first UE, and assigning two of the M−N non-coherent uplink control resources to a second UE.

Further in accordance with exemplary embodiments of this invention the UE 10 of FIG. 2 is constructed to contain circuitry configured to operate in response to an assignment from the eNode B 12 to use one of a coherent uplink shared control resource or a non-coherent uplink shared control resource for at least sending ACK/NACK signaling to the eNode B 12, where the shared control resource is comprised of a PUCCH.

In the UE of the previous paragraph, where the UE is responsive to an assignment of one of coherent uplink control resources for ACK/NACK signaling, or is responsive to an assignment of two non-coherent uplink control resources, one for ACK signaling and the other for NACK signaling.

In the UE of the previous paragraphs, where the UE is responsive to an assignment of one of the non-coherent uplink control resources for use in SR signaling.

In the UE of the previous paragraphs, where at least a portion of the circuitry is embodied in one or more integrated circuit packages or modules.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, and as was noted above, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

As but one example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems. Further, the exemplary embodiments of this invention are not constrained for use with any specific frame format, numbers of long blocks within a frame, sub-carrier mapping scheme and/or type of modulation, as non-limiting examples, that may have been referred to above.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

What is claimed is:

1. A method, comprising:
defining a shared uplink control resource to comprise N out of a possible M uplink control resources as being coherent uplink control resources, where M>N;
defining at least one of a remaining M−N uplink control resources as a non-coherent uplink control resource; and
assigning the N coherent uplink control resources and the at least one M−N non-coherent uplink control resource to user equipment (UE) as needed.

2. The method of claim 1, where the uplink control resources are used for acknowledgement/negative acknowledgement (ACK/NACK) signaling from the UE to a Node B.

3. The method of claim 1, where up to M−N user equipment use at least one of the non-coherent uplink control resources for scheduling request signaling to a Node B.

4. The method of claim 1, where the shared uplink control resource is comprised of a physical uplink control channel (PUCCH).

5. The method of claim 1, further comprising assigning one of the N coherent uplink control resources to a first UE, and assigning two of the M−N non-coherent uplink control resources to a second UE.

6. A computer readable medium encoded with a computer program executable by a processor to perform actions, comprising:
defining a shared uplink control resource to comprise N out of a possible M uplink control resources as being coherent uplink control resources, where M>N;
defining at least one of the remaining M−N uplink control resources as a non-coherent uplink control resource; and
assigning the N coherent uplink control channel resources and the at least one M−N non-coherent uplink control resource to user equipment (UE) as needed.

7. The computer readable medium encoded with a computer program executable by a processor of claim 6, where the uplink control resources are used for acknowledgement/negative acknowledgement (ACK/NACK) signaling from the UE to a Node B.

8. The computer readable medium encoded with a computer program executable by a processor of claim 6, where up to M−N user equipment use at least one of the non-coherent uplink control resources for scheduling request signaling to a Node B.

9. The computer readable medium encoded with a computer program executable by a processor of claim 6, where the shared uplink control resource is comprised of a physical uplink control channel (PUCCH).

10. The computer readable medium encoded with a computer program executable by a processor of claim 6, further comprising assigning one of the N coherent uplink control resources to a first UE, and assigning two of the M−N non-coherent uplink control resources to a second UE.

11. An apparatus, comprising:
a transmitter;
a receiver;
a processor coupled to a memory configured to define a shared uplink control resource to comprise N out of a possible M uplink control resources as being coherent uplink control resources, where M>N;
the processor further configured to define at least one of the remaining M−N uplink control resources as a non-coherent uplink control resource; and
the processor coupled to the transmitter configured to assign the N coherent uplink control resources and the at least one M−N non-coherent uplink control resource to user equipment (UE) as needed.

12. The apparatus of claim 11, where the uplink control resources are used for acknowledgement/negative acknowledgement (ACK/NACK) signaling from the UE to a Node B.

13. The apparatus of claim 11, where up to M−N user equipment use at least one of the non-coherent uplink control resources for scheduling request signaling to a Node B.

14. The apparatus of claim 11, where the shared uplink control resource is comprised of a physical uplink control channel (PUCCH).

15. The apparatus of claim 11, where the processor coupled to the transmitter is further configured to assign one of the N coherent uplink control resources to a first UE, and assign two of the M−N non-coherent uplink control resources to a second UE.

16. The apparatus of claim 11 embodied in at least one integrated circuit.

17. An apparatus, comprising:
means for defining a shared uplink control resource to comprise N out of a possible M uplink control resources as being coherent uplink control resources, where M>N;
means for defining at least one of the remaining M−N uplink control resources as a non-coherent uplink control resource; and
means for assigning the N coherent uplink control channel resources and the M−N non-coherent uplink control resources to user equipment (UE) as needed.

18. The apparatus of claim 17, where the uplink control resources are used for acknowledgement/negative acknowledgement (ACK/NACK) signaling from the UE to a Node B.

19. The apparatus of claim 17, where up to M−N user equipment use at least one of the non-coherent uplink control resources for scheduling request signaling to a Node B.

20. The apparatus of claim 17, where the shared uplink control resource is comprised of a physical uplink control channel (PUCCH).

21. The apparatus of claim 17, further comprising means for assigning one of the N coherent uplink control resources to a first UE, and means for assigning two of the M−N non-coherent uplink control resources to a second UE.

22. An apparatus, comprising:
a receiver;
a transmitter; and
a processor configured to operate in response to the receiver receiving an assignment from a base station to use one of a coherent uplink shared control resource or a non-coherent uplink shared control resource for signaling via the transmitter to the base station.

23. The apparatus of claim 22, where the apparatus is responsive to an assignment of at least one of a coherent uplink control resources or two non-coherent uplink control resources for ACK/NACK signaling.

24. The apparatus of claim 23, where one of the two non-coherent uplink control resources is for ACK signaling and the other is for NACK signaling.

25. The apparatus of claim 22, where the apparatus is responsive to an assignment of one of the non-coherent uplink control resources for use in scheduling request signaling.

26. The apparatus of claim 22, where the shared control resource is comprised of a physical uplink control channel (PUCCH).

27. The apparatus of claim 22 embodied in at least one integrated circuit.
